(19) United States
(12) Patent Application Publication
(10) Pub. No.: US 2014/0093418 A1
(43) Pub. Date: Apr. 3, 2014

(54) PART FOR A COMPONENT FOR HIGH-PRESSURE LIQUID CHROMATOGRAPHY (HPLC), IN PARTICULAR PUMP HEAD FOR AN HPLC PUMP, AND ALSO HPLC PUMP

(71) Applicants: Adolf Satzinger, Olching (DE); Richard Schloderer, Krailling (DE); Stefan Andreas Seitz, Germering (DE)

(72) Inventors: Adolf Satzinger, Olching (DE); Richard Schloderer, Krailling (DE); Stefan Andreas Seitz, Germering (DE)

(73) Assignee: DIONEX SOFTRON GMBH, Germering (DE)

(21) Appl. No.: 14/111,654

(22) PCT Filed: Apr. 16, 2012
(86) PCT No.: PCT/DE2012/100105

§ 371 Date: Nov. 11, 2013

(30) Foreign Application Priority Data
Apr. 15, 2011 (DE) 10 2011 002 109.4

(51) Int. Cl. G01N 30/02; C22C 14/00

(52) U.S. Cl. CPC G01N 30/02; C22C 14/00
USPC 420/418; 420/417; 420/421

(57) ABSTRACT

The invention relates to a part for a component for high-pressure liquid chromatography (HPLC), in particular a pump head for an HPLC pump, in which the strength has been increased by autofrettage and which consists of a material which is essentially chemically inert to the fluids used in HPLC. The invention further relates to an HPLC pump having a pump head which is configured as such a part.

### FIELD OF THE INVENTION

The present invention relates to a part for a component for high-pressure liquid chromatography (HPLC), in particular a pump head for an HPLC pump, and also to an HPLC pump having such a part.

### BACKGROUND

In HPLC, the use of fine-grained column material can achieve a desired shortening of the analysis time and a gain in dissolution. However, this results in an increasing operating pressure. It is therefore desirable that HPLC components and systems can withstand the highest possible operating pressure. Depending on the field of use, the HPLC part therefore has to have the required strength in order to withstand the stresses caused by the pressure. During the operation of HPLC systems, pressure fluctuations or even pulsating loads generally arise. Therefore, it is additionally necessary that the material has a sufficient fatigue strength, i.e. that it has to withstand at least a specific number of pressure cycles.

A further requirement of HPLC parts is a sufficient chemical resistance, so that the contact of the part with various media does not cause any disadvantageous chemical interactions or impurities. In HPLC, salt concentrations typically of up to 10 mol/L and a pH range of 1 to 13 are common. Ultimately, the material also must not release anything which leads to the contamination of the conveyed medium.

High-strength materials having a mechanical load-bearing capacity sufficient for HPLC requirements generally do not have the required chemical resistance and purity. A further problem in the case of many materials is that the costs for the base material or the processing are very high.

Parts having a high fatigue strength for high-pressure applications in HPLC, for example above 800 or 1000 bar, can therefore be produced only with difficulty using conventional or non-strengthened materials.

Various known processes exist for producing parts resistant to high pressure. One known process for producing parts having a high fatigue strength is pressing the part subjected to a high level of loading into a further part. In this so-called shrink assembly, the fatigue strength is increased in the part subjected to a high level of loading by means of compressive stresses. It is disadvantageous in this process that the parts to be pressed have to be highly precise and that the manufacturing process is relatively complicated. This has the consequence that such parts can only be produced at high cost.

A further known process is autofrettage for cast parts. Autofrettage denotes a process for increasing the strength of parts, e.g. of tubes, for use at high internal pressures. In this case, the part is exposed to an internal pressure lying above the later operating pressure and above the yield strength already after it has been produced, so that the regions on the inner wall plasticize. After depressurization, residual compressive stresses arise in this region, preventing cracking during later use and therefore increasing the general compressive strength and the fatigue strength. With this treatment, the parts can either be operated at a higher operating pressure or/and withstand a higher number of load changes than without autofrettage treatment.

This process is also used, for example, in the automotive industry, in order to provide cast parts which can be produced inexpensively with a high fatigue strength also for high-pressure applications. This is known, for example, from the application DE 198 59 188.

The material 17-4 PH, a stainless chromium-nickel-copper steel, is known for general high-pressure applications, and can also be strengthened by autofrettage. However, this material is not suitable for HPLC applications since it does not have the required chemical inertness.

### SUMMARY

It is an object of the present invention, therefore, to provide a part for a component for high-pressure liquid chromatography (HPLC), in particular a pump head for an HPLC pump, which has both a fatigue strength which is sufficient for high-pressure applications and a chemical resistance and purity which is sufficient for HPLC applications, and at the same time can be produced cost-effectively. Furthermore, the invention is based on the object of providing an HPLC pump having a pump head configured as such a part.

The use of autofrettage which has not been used to date for HPLC parts therefore makes it possible for the first time to form parts which are designed for high pressure and at the same time satisfy all requirements in terms of the purity and chemical resistance.

This relates initially to all materials which have the required chemical and physical properties for HPLC. Suitable parts in this respect are in particular, but not exclusively, pump heads, capillaries, switching valves, columns, valves, etc. The invention is also particularly advantageous for parts with bore intersections, since particularly high levels of loading occur there. Suitable possible materials are in particular titanium alloys, for example titanium grades 4, 5, 7, 23, 29, TiAl6V6Sn2, TiAl5Fe2.5, or high-grade steel alloys, for example high-grade steel 1.4571, 1.4462, 1.4305, or certain plastics, for example PEEK.

Among the possible materials, titanium 5 has proved to be particularly suitable. Hereinbelow, “titanium 5” is to be understood as meaning the material Ti-6Al-4V, which according to ASTM standard is also termed “Grade 5” and, according to more recent material nomenclature, bears the number 3.7165.

Tests have shown that titanium 5 is particularly suitable for HPLC applications since it is extraordinarily corrosion-resistant and releases especially few iron ions to the solvent.

Titanium 5 additionally exhibits a very small Bauschinger effect. This has the effect that compressive stresses can be impressed very effectively during the autofrettage. The combination of titanium 5 or even other materials with the strength-increasing process of autofrettage opens up fields of operation, particularly in the field of HPLC, of above 800 bar, preferably up to above 2000 bar, which to date were achievable only with difficulty. The formation of such HPLC components in particular from titanium 5 in combination with autofrettage gives a high static load-bearing capacity combined with a high alternating load resistance and good chemical resistance for operation with the widest possible variety of media. Moreover, titanium 5 can be obtained relatively inexpensively and can be processed very readily. The production of parts which have been subjected to autofrettage is additionally less expensive than the use of shrink assemblies.

The titanium alloy which is preferably used according to the invention for the part has a titanium proportion of at least 75% by weight and a proportion of at least 7% by weight of one or more alloying substances selected from the group consisting of aluminum, vanadium, niobium, zirconium, chromium or molybdenum. A proportion of alloying substances of at least 10% by weight can improve the results for the strength further. A yet further increased proportion of titanium of at least 88% by weight, preferably at least 89% by weight, can also contribute thereto.

Further embodiments of the invention will become apparent from the dependent claims.

### BRIEF DESCRIPTION OF THE DRAWINGS

An application in the field of HPLC will be illustrated hereinbelow with reference to a simple figure example.

FIG. 1 shows, in a schematic sectional illustration, a component 1 composed of a plurality of elements for an HPLC application.

### DETAILED DESCRIPTION OF EMBODIMENTS

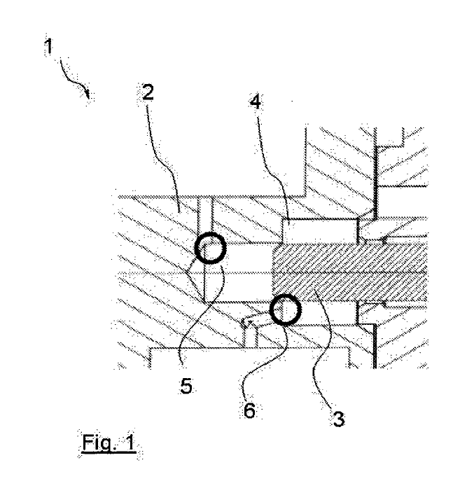

FIG. 1 shows, in particular, a pump head 2, the interior of which is provided with a piston 3 for pressurization or conveying a medium which is provided at high pressure with the aid of the apparatus. The cylinder chamber 4 which is widened in steps is in this case subjected to extremely high mechanical loading, for example, in the region of the circled bore intersections 5 and 6. The bores or recesses represent channels for the inflow or the discharge of a medium to be conveyed.

By subjecting the material used for the pump head 2, in particular titanium 5, to autofrettage, the strength is advantageously increased inter alia at this point, such that the apparatus can be operated reliably at high pressure for an HPLC application and observing all requirements in terms of the chemical and physical resistance of the pump head.

It goes without saying that the above-described HPLC pump represents merely an example for the application of the invention. In principle, it can be employed for all parts or components for HPLC, in particular also for HPLC capillaries, fittings for connecting capillaries to one another or to connections of HPLC components, such as pumps, columns, etc.

1. A part for a component for high-pressure liquid chromatography (HPLC) comprising: a material of the part for HPLC that is strengthened by autofrettage, and in that the material is essentially chemically inert to fluids used in HPLC.

2. The part of claim 1, in which the material comprises a titanium alloy.

3. The part of claim 2, in which the titanium alloy comprises at least 75% by weight titanium and a proportion of at least 7% by weight of one or more alloying substances selected from the group consisting of aluminum, vanadium, niobium, zirconium, chromium or molybdenum.

4. The part of claim 3, in which the proportion of the alloying substances is at least 10% by weight.

5. The part of claim 3, in which the proportion of titanium is at leasst 88% by weight.

6. The part of claim 1, in which the part includes a bore intersection.

7. The part of claim 1, in which the part comprises a pump head for an HPLC pump.

8. A pump for HPLC comprising the pump of claim 7.

9. The part of claim 1, in which the part is selected from a group consisting of a capillary, a switching valve, a column, and a valve.

10. The part of claim 7, in which the pump head includes a region of a plasticized inner wall from exposure to a pressure above a yield strength of the material.
